(19) United States
(12) Patent Application Publication
(10) Pub. No.: US 2019/0197448 A1
(43) Pub. Date: Jun. 27, 2019

(54) Composing Microservices through Workflows for Applications in Engineering Design and Manufacturing

(71) Applicant: Palo Alto Research Center Incorporated, Palo Alto, CA (US)

(72) Inventors: Saigopal Nelaturi, Mountain View, CA (US); Alexandre Perez, Maia (PT); Morad Behandish, Mountain View, CA (US)

(73) Assignee: Palo Alto Research Center Incorporated, Palo Alto, CA (US)

(21) Appl. No.: 15/849,745

(22) Filed: Dec. 21, 2017

(51) Int. Cl. G06Q 10/06; G06F 17/50

(52) U.S. Cl. CPC G06Q 10/06315; G06Q 10/067; G06F 17/5009

(57) ABSTRACT

An approach to architecting engineering design and digital manufacturing software systems by orchestrating several independently deployable, limited in scope, small software components (i.e., microservices). Interactions between these components are composed via first-order descriptions of workflows, allowing the construction of flexible, scalable, resilient systems.

### BACKGROUND

The present disclosure is directed to the development of hardware and software services for use in connection with product lifecycle management (PLM), where today such services are commonly designed and implemented as monolithic systems. PLM systems are, as exemplary shown in FIG. 1, intended to systematically improve and integrate various phases of a product's lifecycle 100, including identification of need 102, conception of the product 104, design/development (including conceptual, preliminary, and detailed design, simulation/analysis, optimization/synthesis) 106, manufacturing/production (including process planning and execution, quality control inspection) 108, and other actions after its sale such as maintenance and recycling 110 (it is understood that FIG. 1 is simply one example of a representation of a PLM environment).

There are various shortcomings in the existing monolithic designs, including but not limited to a tight coupling of the various functions of the existing PLM system. This means changing or adding new functionality becomes an intricate task which may involve a substantial rewrite of the existing codebase. Monolithic systems can also require specialized hardware which may be used by a small subset of functional units, resulting in low utilization rates. Another disadvantage of monolithic systems is that users/customers with a range of needs and purchasing power have to be able to afford the entire system (with or without its specialized hardware) even if they need a small subset of functionality.

Furthermore, the workflow or sequence of computational tasks used in a particular PLM application (e.g. Computer-Aided Design, Computer-Aided Process Planning, Computer-Aided Manufacturing, or some specialized subset of such applications) should determine the software tools required to accomplish the task goals, as opposed to the current software systems where the software tools constrain the applicable workflows. Inverting this paradigm would open up substantial freedom for the end user by providing workflow flexibility at an optimized cost, thereby avoiding situations for example where a small/medium sized business pays tens of thousands of dollars for sophisticated monolithic PLM software although they use only a small subset of the software tools packaged into the PLM system.

The present disclosure is intended to address these and other shortcomings of existing PLM systems.

### BRIEF DESCRIPTION

A performance model measuring the performance of a microservice according to a specified metric (such as running time, execution cost, accuracy and fidelity of results, etc.) can be built offline by running multiple benchmarks. Given inputs at run-time, such a performance model can then be used to rapidly estimate the performance of the microservice without actually executing the PLM service network/system while evaluating different workflows.

Algorithm/representation choices for each computational task can be made automatically to find optimal workflows at run-time. These choices may be optimized not only for a particular application in general, but also for a particular input data and specific instantiation of the workflow, which are fixed up-front in traditional PLM.

An optimized workflow is automatically generated for an application describable in terms of computational tasks supported by some combination of existing microservices.

Multiple software architectures based on different workflows can be generated from the same collection of microservice components, and that these software architectures may be optimized to take advantage of parallel, distributed, and cloud computing.

Nontrivial near-optimal compositions of the same set of computer-aided technology (CAx) components can be obtained by systematic search and orchestration of the space of valid workflows.

Software architectures constructed from microservices can be engineered to be highly resilient in the face of unexpected failures of individual workflows and microservices, based on the trade-offs revealed by the performance models and evaluated by the orchestrator at run time.

### BRIEF DESCRIPTION OF THE DRAWINGS

FIG. 1 illustrates concepts of product lifecycle management (PLM) operations.

FIG. 2 illustrates a block diagram of a PLM service network/system according to the present application.

FIG. 3 provides a particular implementation for the PLM service network/system of FIG. 2.

FIG. 4 provides another particular implementation for the PLM service network/system of FIG. 2.

FIG. 5 shows a distinct workflow created by implementation of particular microservices.

FIG. 6 shows an alternative workflow created by implementation of particular microservices.

FIG. 7 shows a variation of the workflow shown in FIG. 5 where one operation (computing intersections) is replaced by another operation (computing Minkowski sums).

FIG. 8 shows a variation of the workflow shown in FIG. 6 where one operation (computing intersections) is replaced by another operation (computing Minkowski sums).

FIG. 9 is a graph of benchmarks interpolated to build performance models for two algorithms for two distinct microservices.

FIG. 10 is a graph of benchmarks interpolated to build performance models for two algorithms for two microservices performing the same service.

### DETAILED DESCRIPTION

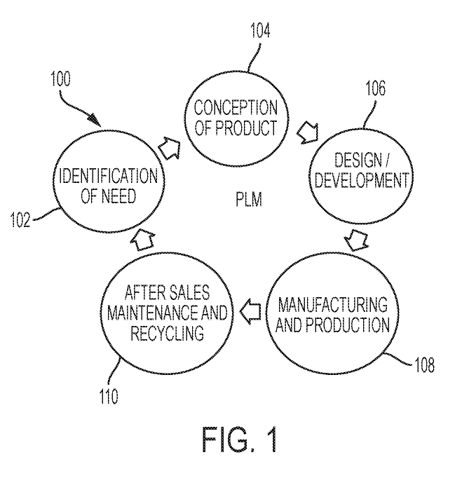

Presently it is common to have product lifecycle management (PLM) systems for use in one or more of the various areas of PLM (e.g., see FIG. 1) built in a monolithic fashion (i.e. where several software libraries solving distinct applications such as CAD or CAM are bundled into a single package) yielding a single large monolithic executable program that performs numerous distinct design-related tasks spanning from, but not limited to, shape and material synthesis, physical simulation, and manufacturing planning, to detailed optimization, tool-path generation, geometric dimensioning and tolerancing, and machine control for product manufacture. While these monolithic systems are comprised of several functional units, these units are tightly coupled, providing the advantages of an integrated software environment for lifecycle management where relationships between functional units are usually optimized for in-memory performance. However, changing or adding new functionality becomes an intricate task with prohibitive development cost and effort as well as high risks of jeopardizing stability, safety, and reliability. Similarly, handling new design tasks that leverage existing functionality in different ways may involve a substantial rewrite of the existing codebase. Another issue with monolithic systems is that expensive specialized hardware is often required to support the broad range of offered functionality, but only used by a small subset of functional units, resulting in low utilization rates. As a result, customers with a range of needs and purchasing power have to be able to afford the entire system (which is costly) as well as the specialized hardware, only if their needs would really require only a subset of the system's functionalities.

The present disclosure includes a concept which in implementation partitions what would otherwise be the monolithic system's functional units into self-contained services with clearly-established interfaces for communicating with the outside world, and orchestrating these independently deployable, limited in scope, small software components (e.g., microservices). Optimal interactions between these components are composed at run-time by the orchestrator using first-order descriptions of workflows, allowing the planning and construction of flexible, scalable, resilient systems. Each of the relevant microservices is able to advertise to an orchestrator component/system of the PLM service network/system its set of capabilities, including, but not limited to, pre- and post-conditions for computation, and potential specific hardware requirements and constraints.

In order to complete a system-level use-case, many of these microservices will be interacting according to a plan of action: a workflow. Workflows describe the functionality provided by the design software as a sequence or network of microservice operations—and their interactions—to achieve a complex task. The same set of microservices may be reconfigured to create functionality that accomplishes many distinct complex tasks, as long as they can be described as a composition of these microservices. Workflows are in certain embodiments represented as (directed) workflow graphs, where nodes describe units of computation—that one or more microservices of the PLM service network/system can perform—and (directed) edges describe the interaction (e.g., flow of information) between two nodes. With a workflow description, services are aware of the computations that preceded them by transitively following the incoming edges of the node under execution. Microservices are also aware of how to format their output messages and where to dispatch them based on the outgoing edges.

The workflow graph itself gets passed around along with the messages between microservices, and can be altered at any point during the computation. Hence, workflows are considered herein as first-order entities that can be mutated by microservices. This means, for instance, that ad-hoc fallback strategies can be created when a given microservice instance goes offline, or that revised plans of action can be followed based on the intermediate results of preceding nodes in the workflow.

To create a workflow, the present disclosure employs the orchestrator component/service that takes a description of a task to be performed, generates a workflow graph outlining the composition of microservices to accomplish the task, and dispatches the initial message to the microservice network. In this disclosure the orchestrator component/system acts as a planner, which constructs sequences of actions—microservice invocations—to achieve the current goal. As new microservices are added to the microservice environment, they advertise their capabilities to the orchestrator so that the microservices in the network can be considered by the orchestrator in future plans (workflows). So the orchestrator transitions just from a load balancer and scheduler to also being a planner that automatically configures the workflow that is appropriate for the execution of the application in question. Some of the particular aspects of the present PLM service network/system disclosed herein are:

Looser Coupling: coupling between different functional units is inherently loosened due to the partitioning into modular units of self-contained function. This means that microservices are easier to enhance, test, and maintain.

Component Re-use: since the same basic functionalities tend to appear as building blocks of many different applications, enabling their re-use in different compositions improves throughput and productivity.

Flexibility: the workflow representation of computation allows for the PLM service network/system to perform a wide range of tasks, composed of small components. Since workflows are first order entities, they can also mutate as the task is underway (useful, e.g., when load balancing or rate limiting) leading to reconfigurable PLM architectures.

Scalability: the distributed nature of the PLM service network/system allows for better horizontal scalability. Microservices with similar hardware requirements can be deployed to the same physical host, increasing the utilization rates of specialized hardware.

Resilience: the orchestrator's ability to reconfigure the workflows on the fly enables stable architectures that can recover quickly from fault in components or connections by exploring alternative, functionally equivalent, compositions.

Maintainability: the functional integrity of individual microservices independently of the rest of the workflow has tremendous implications for long-term maintenance, version control, improvement, and re-architecture of software systems built upon them.

Service Discovery: new microservices can advertise new functionality as they come online, expanding the set of use cases the PLM service network/system can handle.

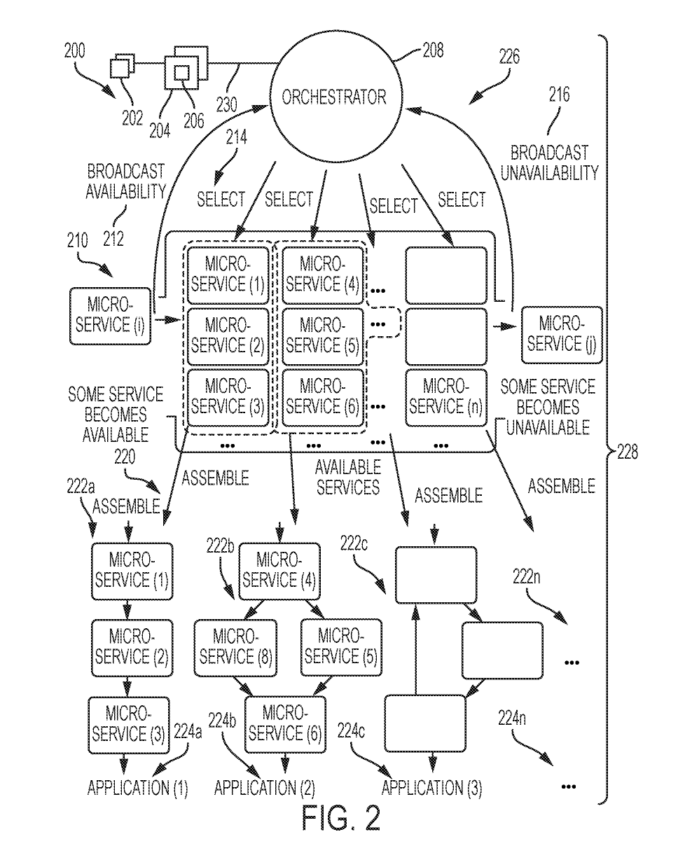

Turning now to FIG. 2, illustrated is a block diagram 200. Users 202 (e.g., end users, developers, etc.) operate one or more client systems 204 which may include a browser 206 designed to interact with an orchestrator component/system 208. Users 202 request certain services or execute various operations (e.g., inputting files to be acted upon) available within the client systems 204. A plurality of microservices 210 exist in the general overall electronic environment, and are broadcasting their availability 212. Based on the user's input to the orchestrator 208, microservices are selected 214 having characteristics necessary for the workflows the orchestrator is generating to complete its tasks based on the input from the users 202.

Microservices are also designed to broadcast their unavailability 216. The selected microservices 214 are assembled 220 into workflows 222a, 222b, 222c, and 222n, which are used as applications 224a, 224b, 224c, 224n to accomplish the appropriate PLM related task.

As can be seen, the microservices that are selected are arranged in a variety of workflows that are appropriate for a particular application by a user. It is understood that the orchestrator 208 is designed not only as a load balancer and scheduler, but is also used herein as a planner as the system is operating (e.g., reconfiguring and optimizing the workflows on the fly), such that new workflows are discoverable and may be integrated during run-time operations.

In the foregoing the orchestrator 208 and microservices 210 (or some sub-set thereof) may be considered as a PLM network/system 226, and where the client systems 204 may optionally be considered also as part of the PLM services network/system 226.

It is understood that the PLM services network/system may be implemented in many environments where, for example, the orchestrator 208 and microservices 210 may be located on servers 228 which include the necessary processing power, memory storage, input/output, connections, and other communications capabilities. It is also appreciated that the orchestrator 208 and microservices 210 are not required to be located on the same server, but rather are commonly located on separate servers. In certain embodiments the PLM services network/system may be implemented on the cloud, which is understood to provide server side capabilities without the software or hardware components being located physically on-site. Additionally, communication between the various components of the PLM services network/system 226 may communicate with each other in any known manner including but not limited to over the internet/intranet or other means of networking 230.

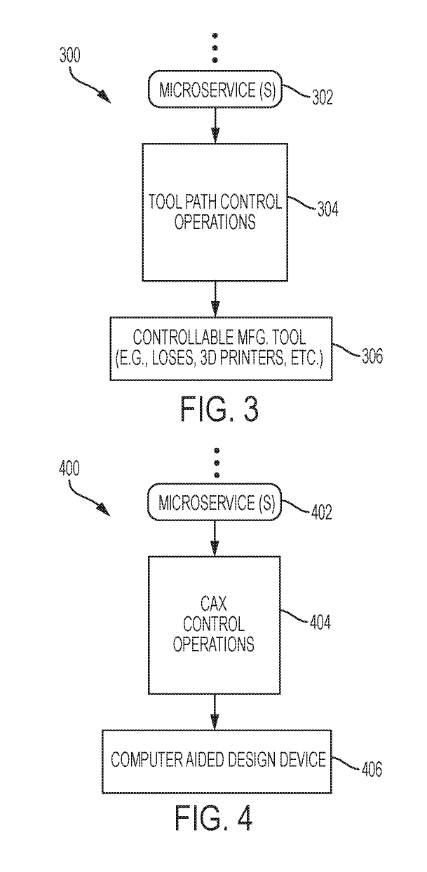

Turning to FIG. 3, illustrated is a portion of an application further extending the discussion of FIG. 2. In particular, as shown in diagram 300, a plurality of microservices 302 are selected and then arranged for a workflow, for example, a tool path control application 304 which is used by a controllable manufacturing tool (e.g., laser-cutter, 3D printer, CNC machine, etc.) 306 whereby the arrangement or workflow of the various microservices 302 are arranged in an application that controls the tool path operation models or final products.

Turning to FIG. 4, illustrated is another system 400 where microservices 402 are selected arranged in a computer-aided technology (CAx) system application 404 such as previously discussed in the same manner as discussed in the foregoing. It is understood that while in this embodiment, particular CAD systems/components are particular embodiments of a general computer-aided technology (CAx) system, other computer-aided design (CAD), manufacturing (CAM), engineering (CAE), process planning (CAPP), assembly planning (CAAP), and other systems for virtual/digital prototyping may also be viewed as CAx systems/components.

Thus, FIGS. 3 and 4 are illustrative of particular operations within a product lifecycle management (PLM) environment where the present concepts of the PLM service network/system 200 of FIG. 2 may be implemented. It is to be understood, however, that the present concepts are applicable to all phases of PLM.

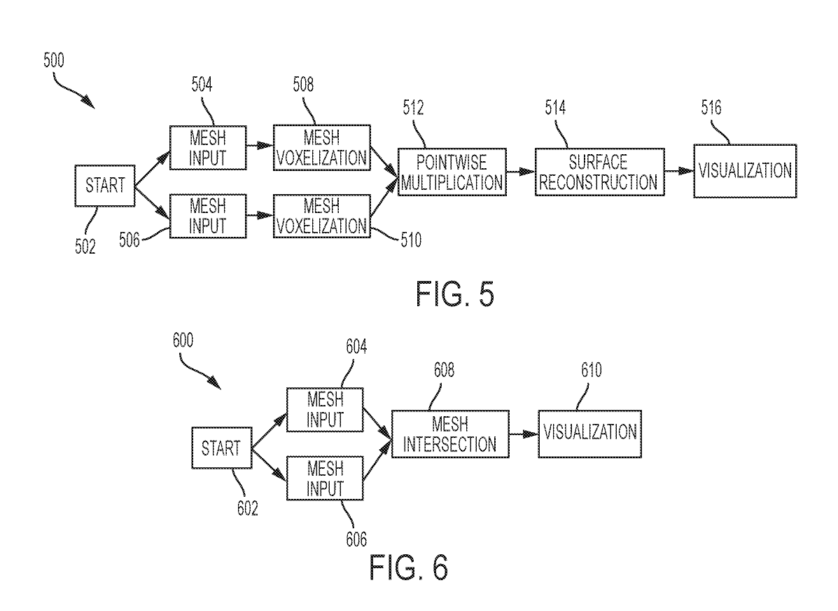

FIGS. 5 and 6 show two distinct workflows 500, 600 created following separate start operations 502, 602 (e.g., two files are input by a user) from the following microservices—mesh input 504, 506, 604, 606, mesh voxelization 508, 510, mesh intersection 608, pointwise multiplication 512, surface reconstruction 514, and visualization 516, 610. Both workflows 500, 600 address the problem of computing the intersection of two mesh models.

With continuing attention to FIGS. 5 and 6 illustrated are examples of how workflows are constructed using PLM services network/system 200 of FIG. 2.

As mentioned workflow 500 of FIG. 5, is intending to solve the problem of computing an intersection of two solids represented by their boundaries as surface meshes. A surface mesh is a polygonal tessellation of a surface that bounds a solid model, and is considered a valid representation of the solid model.

Workflow 500 samples the mesh (microservice read mesh 504, 506) into a regular 3D grid and indexes each sample point with a value of 0 (for points outside the solid) or 1 (for points inside the solid). In other words, the meshes are converted to volumetric binary images, called voxelization (microservice mesh voxelization 508, 510). The intersection of volumetric binary images, aka binary voxels, can be accomplished in a straightforward fashion by pointwise multiplication (microservice pointwise multiplication 512) of the two images (effectively a logical AND operation). A surface can be extracted from the resulting binary voxels using standard surface reconstruction algorithms (microservice surface reconstruction 514), and then displayed (microservice visualization 516). The workflow 500 is inexact and involves representation conversion between mesh models and voxels, but can approximate the exact result up to any desired accuracy. It is faster to compute at the expense of occupying more computer memory space.

Alternatively, for the same problem, workflow 600 of FIG. 6 is initially similar following the start operation 602, by employing mesh reading from file (microservice mesh input 604, 606), but then computes the mesh intersection (microservice mesh intersection 608) directly by intersecting each of its polygonal elements followed by trimming, classification, and selection of polygons bounding the intersection solid. It is more accurate and requires fewer representation elements (thus occupying less computer memory space), but requires more complicated formulations and algorithms.

Consider now a variation of the workflow shown in FIGS. 5 and 6. The only difference is that now the Minkowski sum of two solids (a very important operation in spatial planning problems for design and manufacturing) is computed instead of the intersection operation, so only one microservice in the previous workflows is replaced. The rest of the workflows are intact, as they pertain to representation conversions that are common to this and many other tasks. However, in this case the workflow with voxelized representations is more efficient because Minkowski sum algorithms on meshes are quite complex compared to the implementation using voxels. In this disclosure we are concerned with automatically generating an optimized workflow that chooses the appropriate representations and algorithms based on minimizing an overall objective function. The objective function takes into account various factors such as computation time/memory, accuracy, model degradation (due to numerous conversions), stability, and robustness.

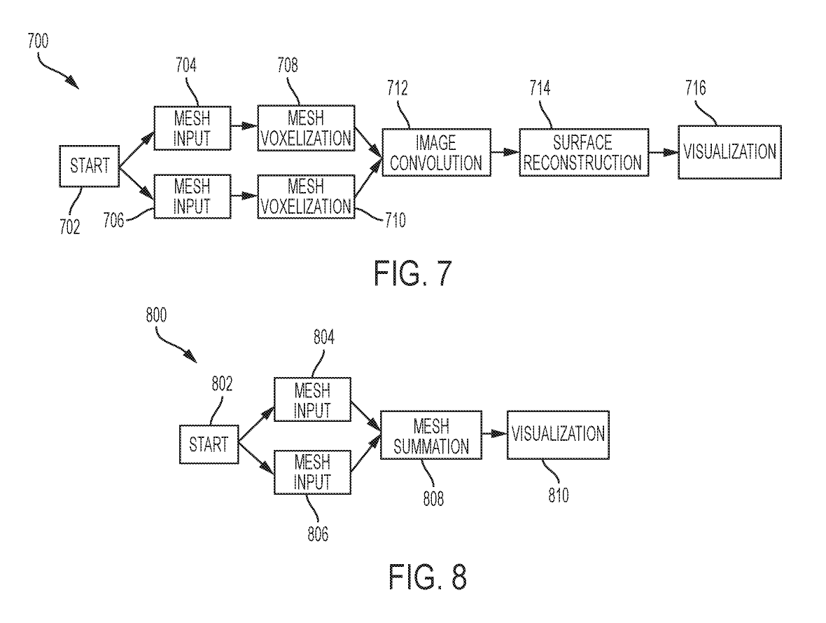

More particularly to workflow 700 of FIG. 7, this workflow includes similar microservices as in FIG. 5 (i.e., after start 702, microservice mesh input 704, 706, mesh voxelization 708, 710, surface reconstruction 714, and visualization 716). The variation from the workflow shown in FIG. 5, is where computing the Minkowski sum on voxels (microservice image convolution and/or more generally convolution 712) is undertaken, a more complex operation seen in spatial planning operations. In this case the workflow 700 involving mesh voxelization 708, 710 is more efficient (i.e. has less computational cost), although it involves more operations. Similarly in workflow 800 of FIG. 8, similar microservices to workflow 600 of FIG. 6 is used, i.e., after start 802, microservices mesh input 804, 806, and visualization 810 are used, with microservice mesh summation 808 as a replacement to image convolution 712 for computing some representation of the Minkowski sum.

i.—A performance model measuring a design performance of a microservice according to at least one specified metric (such as running time, execution cost, accuracy and fidelity of results, etc.) can be built offline by running multiple benchmarks. Given inputs at run-time, such a performance model can then be used to rapidly estimate the performance of the microservice without actually executing the PLM service network/system, while evaluating different workflows.

Each microservice is implemented using a particular algorithm and representation and thus has an inherent computational complexity associated with executing it. The complexity is defined as a function, of the representation. For example, implementing the Minkowski sum of two polyhedra may take O(n̂3 m̂3) basic operations where n and m represent the number of polygons in the input meshes. The voxel based approach could either be a brute force algorithm of complexity O(n̂2) if both inputs are sampled on a grid of size n and every voxel is summed against every other voxel, or a more intelligent algorithm based on the fast Fourier transform (FFT) which has O(n log n) complexity. Traditional complexity analysis can help build models of best-, average-, or worst-case performance for each microservice that implements a CAx operation. But this type of asymptotic performance analysis typically does not include the input- and algorithm-dependent complexity coefficients that can significantly affect the run-time performance of such services.

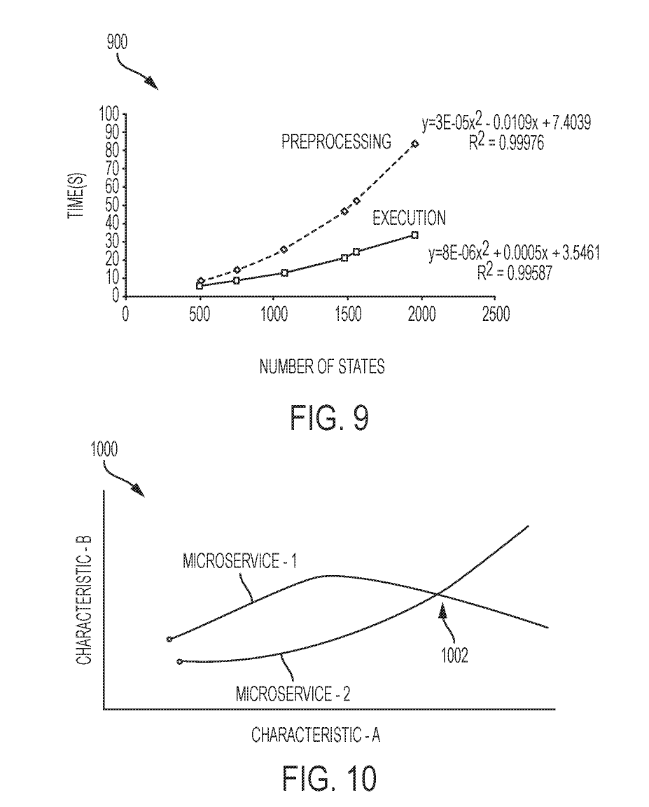

The forgoing discussions leads to the observation that a performance model for each microservice can be built by running several benchmarks offline. The running time for each benchmark may be characterized in terms of the input size, and the algorithm complexity is quantified either using formal algorithm analysis as described above, and/or additionally by building an experimental performance model through the performance data points generated for each benchmark. Graph 900 of FIG. 9 shows an example of building these models for two distinct microservices, one called ‘preprocessing’ and the other called ‘execution’. Each algorithm is run for a different set of inputs (in this case, the number of states). The running time for each input is plotted against the input and a best fit interpolation curve (in this case a quadratic polynomial) is computed. Given any input size, it is thus possible to estimate the computation time by simply evaluating the polynomial.

Thus expanding this discussion more generally, models for each microservice can be built by running any number of function regression methods including but not limited to machine-learning algorithms that estimate the computational time or any other useful metric such as cost, accuracy, memory requirements, and so on, as a function of the input size expected by a particular microservice. In this discussion this model is called the performance model. The performance model has the important property that it rapidly returns an estimate of the metric given a specific input in a format accepted by the microservice of interest.

With continuing attention to graph 900 of FIG. 9, a point being taught is that at run-time, something is known about the input in terms of its size—how big it is for example or how many states to search, etc. Knowing the size, for example, would allow the size of the input to be roughly correlated to the amount of time needed to execute the microservice. Knowing this, if the objective is to perform as quickly as possible then, even if there are multiple microservices that would work, the orchestrator will pick the one that would be more effective time-wise.

Of course when there are multiple objectives the process is further complicated. For example a user may prioritize the accuracy and time for a particular process. When there are multiple objectives they could be selected in a hierarchical manner, so only one objective is selected as the most important or primary objective, or they could be combined into a single objective (e.g., using a weighted sum or other formulae). Alternatively, multi-objective methods such as tracing Pareto fronts can be employed to find proper trade-offs between the different objectives.

Turning to FIG. 10 illustrated is a generic graph 1000, where two microservices (microservice-1 and microservice-2) which perform the same or equivalent function or operation are charted against two generic characteristics (Characteristic-A and Characteristic-B). As shown at point 1002 microservice-2 crosses over microservice-1 as to the Characteristic-B. So the graph may indicate that choosing microservice-2 is more advantageous prior to the cross-over point 1002, while microservice-1 becomes more advantageous thereafter. For example, the same operation (microservices) for the different input sizes might exhibit such behavior in one or more cross-over points. So the orchestrator will at run-time decide which is most advantageous choice for a particular input. Such on-the-fly changes cannot happen in a traditional PLM system as workflows are fixed ahead of time and are applied in the same fashion regardless of the input characteristics revealed at run-time.

It is recognized that properties of the input may affect the actual running time of the algorithm. For example, if a microservice implements a sorting algorithm is presented with input that is already sorted (or approximately sorted), the execution time will be much smaller than if a very unsorted input is provided. Nevertheless the performance model can provide a useful estimate of the best-, average-, or worst-case performance, or an expected performance based on a particular likelihood of input distribution (known a priori), which must be considered while constructing the workflow.

ii.—Algorithm/representation choices for each computational task can be made automatically to find optimal workflows at run-time.

It is understood that numerous implementations often exist for a single computational task in design and manufacturing applications. For example, calculating whether or not a given point in the three-dimensional (3D) space is inside or outside a given solid model can be implemented in a variety of ways. Each implementation is optimized for a particular representation (e.g. ray tracing algorithms may be used for boundary representations, whereas a simple voxel look-up suffices if the solid model is represented as a volumetric binary image).

Taking an assumption that each implementation (i.e. particular algorithm and representation) for a single task exists as a microservice where again microservices are defined to be self-contained applications implementing a small set of computational tasks), it may not be evident a priori which microservice is best suited for the application (e.g., problem to be solved) at hand because the workflow is not fixed upfront. However, as performance models for the metric to be minimized in the optimal workflow are available a priori for each microservice (per discussion heading “i” above), the orchestrator will pick the workflow with the best expected performance, or accuracy, or any other metric for which performance models are computed for each microservice.

Challenges occur in practice when the PLM service network/system addresses CAx applications where multiple representations (and associated algorithms) must be managed. Representation conversion is often desired to alleviate algorithm complexity; e.g. implementing the two workflows in FIGS. 7 and 8 will show that the conversion of large mesh models into volumetric binary images facilitates fast computation of the Minkowski sum using fast Fourier transforms (FFT). The microservice mesh voxelization (i.e., 708, 710 of FIG. 7) converts the representation from a mesh to an image. The orchestrator selects the workflow requiring this representation conversion when the input models are sufficiently large. For smaller input mesh models, it may be faster to compute the mesh based Minkowski sum. This is a reason why microservices that perform representation conversion with pre-computed performance models are invoked by the orchestrator as it plans for optimal workflows. When a representation conversion service is part of the available microservices, the orchestrator will automatically evaluate the cost and efficiency of a workflow involving such conversions, and therefore will automatically select the appropriate algorithm and representation. It is mentioned that the chosen algorithm and representations are consequences of optimizing a workflow metric, and that representations to implement a computational task are not arbitrarily fixed a priori (as they often are in a traditional monolithic PLM system). The flexibility and configurability of the workflows enable dynamically adapting to a priori unknown circumstances (such as input size, desired accuracy, time budget, etc.).

With attention to the meaning of “algorithm/representation”, it is to be understood each microservice has a particular algorithm which receives, operate on, and returns (as input, intermediate state, and output) one or more particular representation(s), where the representation refers to how a certain information model of a product is stored in the computer via data structures, operated on by algorithms, visualized by display devices, interpreted by users, and so on.

While it is possible for a single algorithm to have multiple representations and these may be employed within the presently discussed concepts, it is understood in the presently discussed concepts, each microservice includes at least one algorithm for each representation.

To also clarify, the orchestrator is creating the workflow at run-time, so a user at this point has provided the input which provides enough information that the orchestrator can find microservices to complete the task that it is asked to complete.

Because benchmarks have been calculated for each of the objective functions, the workflow can be optimized for that function.

iii.—An optimized workflow is automatically generated for an application describable in terms of computational tasks supported by some combination of existing microservices.

At run-time, the orchestrator continuously executes a search algorithm that uses the performance model evaluated for each microservice as a heuristic to find the next best action. An action is defined by three parameters—a precondition, an effect, and a cost. A precondition is required to be defined for an action to be applicable. This includes specifying the input in a standard/expected format to the microservice. The cost for the service can be computed using the performance model as mentioned earlier. However, without executing the service online to find the effect, type matching (which is an objective test consisting of two sets of items to be matched with each other for a specified attribute) may be used to describe the next applicable service. For example, if the effect of a particular microservice is a polygonal mesh, the next service in the workflow must accept a polygonal mesh as part of its preconditions. All the input types required to properly execute a microservice must be in place before it can be considered in a workflow.

Traditional search algorithms can be applied to synthesize the workflow based on the required inputs and outputs. It is also possible that specific microservices may be grouped into higher levels of abstraction to facilitate easier planning. For example, the application ‘compute intersection of two solids’ can have at least the two implementations shown in FIGS. 5 and 6, along with other possible implementations on different representations. The grouping is also accompanied with a performance model and expressed as an action so that the orchestrator operating in a planner mode can save time by not evaluating combinations of lower-level microservices. The workflow synthesis problem now reduces to finding a path in the space of actions that minimizes a prescribed metric, and efficient implementations are possible because the effect of each action is precomputed.

iv.—Multiple software architectures based on different workflows can be generated from the same collection of microservices, and that these software architectures may be optimized to take advantage of parallel, distributed, and cloud computing.

With each action, a parameter may be associated called ‘resources’ that indicates the required resources to spawn the associated microservice while executing the workflow. Workflows may be constrained to use a pre-specified set of resources, e.g. multiple many-core graphics processing units (GPUs) and a 10 core central processing unit (CPU) machine, implying that all microservices that use resources not included in or otherwise incompatible with this set are automatically ignored. For example, a lot of solid modeling operations on voxel representations can be efficiently implemented using highly parallel algorithms on CPUs and GPUs, some optimized for one architecture more than others. Moreover, distributed computing over numerous servers may be available, each with their own composition of CPU/GPU-based parallel architectures. The availability of such resources can dramatically affect the configured workflows.

As an example, it is assumed that microservices may be running on a cloud. All customers that might be using the PLM service network/system are provided with the same content—they all see the same embodiment of the PLM service network/system. The customers provide inputs in the same manner. However, some customers may be paying a fee while others are getting the PLM services for free. Different business models can be used; for instance, customers receiving the PLM services for free might have to wait a little longer to obtain the same results, compared to those customers paying an extra fee. The paying customers may receive the results within a guaranteed time, while others may have to accept uncertainties. In order to generate the faster results the PLM service will, in this example, take advantage of parallel computing (e.g., using GPUs). Therefore this shows that different system designs with different service-oriented business models can be implemented for the same system

Furthermore, the changes may be accomplished on-the-fly. For example, depending on what type of user profile there is, the PLM service which is running on the cloud may alter the system architecture for payment of a fee for faster results and may employ a system architecture that includes the use of additional resources (e.g., parallel computing), where for the free version it would not use the same system architecture. The users might even prior to and/or at run-time be presented with their access (or lack thereof) to better computational resources and be given the option to upgrade their service level at the cost of extra fees. This can occur both prior to and/or at run-time, thanks to the previously discussed benchmarking of microservices.

v.—Nontrivial near-optimal compositions of the same set of CAx components can be obtained by systematic search and orchestration of the space of valid workflows.

The orchestrator systematically explores the combinatorial space of different compositions of microservices and enumerates different valid workflows. The validity check for the candidate workflows amounts to type matching and satisfaction of preconditions that can be done automatically (as discussed in topic heading “iii” above). Unlike traditional PLM solutions in which relatively simple and intuitive workflows are commonplace and fixed upfront, the orchestrator is able to come up with new workflows that fit a particular application scenario, even if such workflows have not been observed in different operating conditions.

As more effective microservices become available over time in the ecosystem and broadcast their capabilities (including but not limited to: preconditions, effects, and cost) the orchestrator has more freedom in generating novel solutions. For example, as soon as a new microservice (e.g., fast Fourier transform (FFT)) appears and broadcasts its ability to faster/cheaper compute discrete Fourier transform (DFT) (on which the microservice image convolution 712 in FIG. 7 depends) the orchestrator will be able to generate new voxel-based solutions that are superior in computing cost, which were not cost-effective before. The dynamic flexibility and adaptability to new and improved resources is a particular feature of microservice-oriented architectures.

vi.—Software architectures constructed from microservices can be engineered to be highly resilient in the face of unexpected failures of individual workflows and microservices, based on the trade-offs revealed by the performance models and evaluated by the orchestrator at run-time.

The orchestrator is also able to construct multiple workflows at run-time that perform the same function through different combinations of microservices. Despite functional equivalence, these solutions will differ in cost, accuracy, fidelity, and particularly relevant to this discussion how they react to errors and failures (e.g., in fulfillment of explicit preconditions or other implicit assumptions). The performance model obtained from benchmark scenarios provides a capability to compare the workflows and understand the tradeoffs. Moreover, qualitatively distinct workflows that have substantially different failure modes are able to be coupled to augment each other in performing the common tasks, increasing resilience and robustness at the cost of functional redundancy. For example, if a microservice in a workflow suddenly goes offline the orchestrator can reconfigure a new workflow based on other online microservices that can be used instead. In addition to workflow failures (e.g., due to specific combinations of representations), failures at individual component level (e.g., a server carrying a microservice in question fails) can be detected and resolved independently of the remainder of the workflow. The ability to replace components with functionally equivalent components (in terms of preconditions, effects, and cost) facilitates long term maintainability of reliable and resilient PLM services (e.g., such as CAx systems).

The above described PLM services network/system in certain embodiments be configured to develop a plurality of workflows where each of the workflows are intended for a same process to be performed. Thereafter the network/system will pick the most appropriate for a problem to be solved. Other ones of the workflows that were not selected as an optimal workflow, may be used as a backup that could be selected should an issue with the primary workflow occur.

Adding features to monolithic solutions requires broad understanding of the code base for all tightly coupled components and updating convoluted connections. Every such change comes at a risk of jeopardizing the overall integrity of the monolithic system, its backward compatibility, functional reliability, and unpredictable side-effects. As such, monolithic PLM solutions are difficult to extend and are doomed to face economic and operational resistance to change. Microservices are far more extensible by design, and scale without a concern for unpredictable long-distance effects of a given component's internal structure on the rest of the system.

It will be appreciated that variants of the above-disclosed and other features and functions, or alternatives thereof, may be combined into many other different systems or applications. Various presently unforeseen or unanticipated alternatives, modifications, variations or improvements therein may be subsequently made by those skilled in the art which are also intended to be encompassed by the following claims.

What is claimed is:

1. A product lifecycle management (PLM) services network/system comprising;
an orchestrator configured as a load balancer scheduler and planner; and
a plurality of microservices selected by the orchestrator to generate workflows.

2. The PLM services network/system according to claim 1, wherein each microservice has a performance model measuring a design performance of a corresponding microservice according to at least one specified metric which is built offline by running multiple benchmarks, wherein for given inputs at or prior to run-time such a performance model is used to estimate the performance of the microservice without actually executing the service, while evaluating different workflows.

3. The PLM services network/system according to claim 1, further including a client system including a web browser for communication with the orchestrator.

4. The PLM services network/system according to claim 1 wherein the specified metric includes at least one of running time, execution cost, accuracy and fidelity of results.

5. The PLM services network/system according to claim 1 wherein algorithm/representation choices for each computational task are made automatically to find optimal workflows at run-time.

6. The PLM services network/system according to claim 1 wherein an optimized workflow is automatically generated for an application describable in terms of computational tasks supported by a combination of existing microservices.

7. The PLM services network/system according to claim 1 wherein multiple software architectures are generated from each workflow, and the generated software architectures are optimized to take advantage of parallel computing.

8. The PLM services network/system according to claim 1 wherein nontrivial near-optimal compositions of the same set of CAx components can be obtained by systematic search and orchestration of the space of valid workflows

9. The PLM services network/system according to claim 1 wherein software architectures constructed from microservices are engineered to be resilient in the face of unexpected failures of individual workflows and microservices, based on trade-offs revealed by performance models and evaluated by the orchestrator at run time.

10. A method of providing product lifecycle management (PLM) services comprising;
orchestrating PLM services by use of an orchestrator configured as a load balancer scheduler and planner; and
selecting from among a plurality of microservices by the orchestrator to generate workflows.

11. The method according to claim 10, wherein each microservice has a performance model measuring a design performance of a corresponding microservice according to at least one specified metric which is built offline by running multiple benchmarks, wherein for given inputs at or prior to run time such a performance model is used to estimate the performance of the microservice without actually executing the service, while evaluating different workflows.

12. The method according to claim 10 further including communicating between the orchestrator and a client system, wherein the client system includes a web browser.

13. The method according to claim 10 wherein the specified metric includes at least one of running time, execution cost, accuracy and fidelity of results.

14. The method according to claim 10 wherein algorithm/representation choices for each computational task are made automatically to find optimal workflows at run-time.

15. The method according to claim 9 wherein an optimized workflow is automatically generated for an application describable in terms of computational tasks supported by a combination of existing microservices.

16. The method according to claim 10 wherein multiple software architectures are generated from each workflow, and the generated software architectures are optimized to take advantage of parallel computing.

17. The method according to claim 10 wherein nontrivial near-optimal compositions of the same set of CAx components can be obtained by systematic search and orchestration of the space of valid workflows.

18. The method according to claim 9 wherein software architectures constructed from microservices are engineered to be resilient in the face of unexpected failures of individual workflows and microservices, based on trade-offs revealed by performance models and evaluated by the orchestrator at run-time.
